(19) United States
(12) Patent Application Publication
(10) Pub. No.: US 2011/0203876 A1
(43) Pub. Date: Aug. 25, 2011

(54) Narrow Aisle Stacker Crane

(75) Inventors: Russell John Skinner, Queensland (AU); Luis Alexandre Oliveira, Moreira da Maia (PT); David Haberland, New South Wales (AU)

(73) Assignee: Recall Corporation, Norcross, GA (US)

(21) Appl. No.: 12/852,868

(22) Filed: Aug. 9, 2010

Related U.S. Application Data
(63) Continuation of application No. 12/638,487, filed on Dec. 15, 2009, now abandoned.
Application No. 12/638,487 is a continuation-in-part of application No. 11/554,306, filed on Oct. 30, 2006, now abandoned.
(60) Provisional application No. 60/732,465, filed on Oct. 31, 2005.

(51) Int. Cl. B66B 9/16

(52) U.S. Cl. 187/240

(57) ABSTRACT

A narrow aisle stacker crane is provided, which includes a base unit capable of traveling along aisles in a warehouse and a mast structure that is connected to the base unit. The mast structure may have a height greater than approximately 10 m. A hoisting carriage for an operator, with an attached load carrying platform, is included and is arranged to travel vertically along the mast. The base unit, the hoisting carriage and the load-carrying platform are sized to travel along warehouse aisles of 0.9 m to 1 m in width. The velocity of the base unit in a horizontal direction may be between 1 m/s to 5 m/s. The velocity of the hoisting carriage and load-carrying platform in the vertical direction may be less than 1.5 m/s. Horizontal movement of the base unit and vertical movement of the hoisting carriage and load-carrying platform may take place at the same time, so that fast item placement and retrieval can take place despite relatively low movement speeds.

### CROSS-REFERENCE TO RELATED APPLICATIONS

The present application is a continuation of U.S. patent application Ser. No. 12/638,487 filed Dec. 15, 2009, which is a continuation-in-part of U.S. patent application Ser. No. 11/554,306 filed Oct. 30, 2006, which claims priority from U.S. Patent Provisional Application. No. 60/732,465, filed Oct. 31, 2005, the contents of which are herein incorporated by reference in their entirety.

### FIELD OF THE INVENTION

This invention relates to lifting or stacker cranes. More particularly, this invention relates to a narrow aisle stacker crane, also known as a rack access vehicle, for use in a warehousing system.

### BACKGROUND

Traditional warehousing systems involve the use of large, single-storey warehouses having wide aisles that are placed between storage areas, such as shelving, to provide passages for fork-lift trucks or other goods conveyancing equipment. However, high land costs have meant that traditional single-storey warehouse models are not cost-effective in many instances. Various other drawbacks exist.

It is desirable to provide a system of operating a warehouse facility to achieve a greater space efficiency than is currently achievable. Ideally, the warehouse facility should include narrow aisles that are placed between storage areas. The storage areas should be built to a greater height than current systems in order to maximize storage space on the same footprint of land.

Many systems for improving storage efficiency have been proposed. However, a need still exists for stacker cranes that enable warehouses to be constructed with space efficient designs having narrow aisles between storage areas.

### SUMMARY OF THE INVENTION

Various aspects of the invention overcome at least some of these and other drawbacks of existing systems. According to one arrangement, the invention provides a stacker crane for use in warehouses, among other facilities. The stacker crane includes a base unit that is capable of traveling between aisles in a warehouse. According to one arrangement of the invention, the base unit may includes a transport mechanism, such as wheels. According to another arrangement of the invention, the base unit may be configured to run along a rail system.

According to one arrangement, the base unit may be coupled to a mast structure that ascends upward to enable access to storage areas, such as shelving, in a warehouse environment. According to one arrangement, the mast structure may ascend to a height greater than 10 m. The mast structure may be moveably supported at an upper end by a guiding rail system or other supporting system.

According to one arrangement of the invention, a hoisting carriage may be provided that travels vertically along the mast structure. According to another arrangement of the invention, the hoisting carriage may be provided to travel horizontally relative to the mast structure. According to another arrangement of the invention, the hoisting carriage may be configured to include a load-carrying platform that receives palletized goods, containers of goods, loose goods and/or other load configurations from the storage areas of the warehouse environment.

According to one arrangement of the invention, the hoisting carriage may be configured to carry an operator thereon. According to one arrangement of the invention, operator controls may be included in the hoisting carriage. According to another arrangement of the invention, the operator controls may include a contact pad that is engaged by the operator's back, such that the crane will not operate unless the operator is seated.

According to one arrangement of the invention, at least one motor may be provided to impart motive forces to the hoisting carriage and the base unit. According to one arrangement of the invention, the base unit, the hoisting carriage and the load-carrying platform may be sized to travel along aisles having widths of approximately 0.8 m to approximately 1.3 m. According to another arrangement of the invention, the base unit may be imparted with a horizontal velocity for moving the narrow aisle crane across a floor at approximately 1 m/s to approximately 5 m/s. According to one arrangement, the horizontal velocity may be provided along a direction that is substantially horizontal relative to the floor. According to one arrangement of the invention, the hoisting carriage and load-carrying platform may be imparted with a vertical velocity for moving the hoisting carriage and load-carrying platform along the mast structure at less than approximately 1.5 m/s. According to one arrangement of the invention, the vertical velocity may be provided along a direction that is substantially vertical relative to the floor.

According to one arrangement of the invention, the movement of the base unit in the substantially horizontal direction may proceed concurrently with the movement of the hoisting carriage and the load-carrying platform in the substantially vertical direction. The resultant concurrent movement of the hoisting carriage and the load-carrying platform in the horizontal and vertical directions relative to the floor increases the speed of arrival to the designated location, despite the relatively slow individual velocities of the base unit in the horizontal direction and the hoisting carriage and the load-carrying platform in the vertical direction.

According to another arrangement of the invention, the base unit may be designed with a horizontal velocity of approximately 1.5 m/s to approximately 3 m/s. According to another arrangement of the invention, the hoisting carriage and load-carrying platform may be designed to include a vertical velocity of approximately 0.25 m/s to approximately 0.75 m/s. According to another arrangement of the invention, the mast height may be greater than approximately 15 m. According to yet another arrangement of the invention, the mast height may be approximately 19 m to approximately 25 m.

According to one arrangement of the invention, the base unit may be arranged such that, when completely lowered, the height of the load-carrying platform relative to the floor level is less than approximately 0.75 m. According to another arrangement of the invention, the base unit may be arranged such that, when completely lowered, the height of the load-carrying platform relative to the floor level is between approximately 0.3 m to approximately 0.7 m. According to yet another arrangement of the invention, the base unit may be arranged such that, when completely lowered, the height of the load-carrying platform relative to the floor level is approximately 0.45 m.

According to another arrangement of the invention, the mast structure may include a width of approximately 0.6 m to approximately 0.9 m. According to another arrangement of the invention, the mast structure may be configured to support a weight limit for the hoisting carriage and load-carrying platform of approximately 350 kg to approximately 650 kg. According to another arrangement of the invention, the carriage and the load-carrying platform may be sized to travel along warehouse aisles having widths of approximately 0.9 m to approximately 1 m.

According to one arrangement of the invention, a transfer structure may be provided for receiving the stacker crane assembly. According to one arrangement of the invention, the transfer structure may include a rail system for guiding the stacker crane assembly onto the transfer structure. In another arrangement, of the invention, the transfer structure may include a vertical support structure that engages the mast structure of the stacker crane. In another arrangement of the invention, the transfer structure may include a transport mechanism that enables the transfer structure to transport the stacker crane between two or more aisles. In another arrangement of the invention, the transfer structure may transport the stacker crane along a path that is substantially perpendicular between the starting aisle rail and the destination aisle rail. In another arrangement of the invention, the transfer structure may transport the stacker crane along a path that is curvilinear between the starting aisle rail and the destination aisle rail.

These and other aspects and features of the invention will become apparent upon review of the enclosed drawings and detailed description below. It is also to be understood that both the foregoing general description and the following detailed description are exemplary and not restrictive to the scope of the invention. Numerous other objects, features, and advantages of the invention should become apparent upon a reading of the following detailed description of which is included below.

### BRIEF DESCRIPTION OF THE DRAWINGS

The accompanying drawings, which are incorporated in and form a part of the specification, illustrate embodiments of the presently disclosed invention and, together with the description, discloses the principles of the invention.

FIG. 1 illustrates a perspective view of a narrow aisle stacker crane according to one embodiment of the invention.

FIG. 2A illustrates a top perspective view of the base unit according to the illustrated embodiment of the invention.

FIG. 2B illustrates a bottom perspective view of the base unit according to the illustrated embodiment of the invention.

FIG. 3A illustrates a rear perspective view of an upper portion of the mast structure according to the illustrated embodiment of the invention.

FIG. 3B illustrates a front perspective view of an upper portion of the mast structure according to the illustrated embodiment of the invention.

FIG. 4 illustrates a hoisting carriage and load carrying platform according to the illustrated embodiment of the invention.

FIG. 5 illustrates a transfer car according to the illustrated embodiment of the invention.

FIG. 6 is a top schematic view showing a transfer car and stacker crane together with exemplary ground rail alignments.

FIG. 7 is a top schematic view showing a transfer car and stacker crane together with exemplary upper rail alignments and rail funnel.

FIG. 8 illustrates an arrangement of rail funnel according to the illustrated embodiment of the invention.

FIG. 9A illustrates an arrangement of a mast structure guide bar according to the illustrated embodiment of the invention.

FIG. 9B illustrates an arrangement of a mast structure guide bar according to the illustrated embodiment of the invention.

FIG. 10A illustrates an arrangement of a mast structure guide bar in position on a transfer car column according to the illustrated embodiment of the invention.

FIG. 10B illustrates an arrangement of a mast structure guide bar in position on a transfer car column according to the illustrated embodiment of the invention.

### DETAILED DESCRIPTION OF CERTAIN EMBODIMENTS OF THE INVENTION

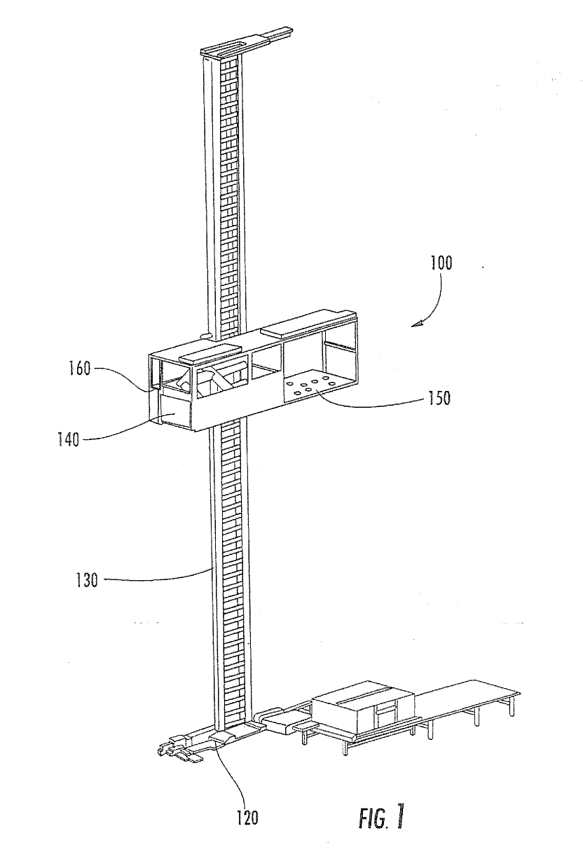

FIG. 1 illustrates a narrow aisle stacker crane 100 according to one embodiment of the invention. The stacker crane 100 may include numerous configurations for use in warehousing systems or other stacking systems. There is a need for providing cost-effective solutions to facilities, such as warehousing facilities, storage facilities and/or other facilities, that employ tall structures to store goods. The tall structures may include shelves that are separated by narrow aisles. The narrow aisles provide less floor space for passage between adjacent tall structures. Thus, more floor space is available for placement of the tall structures, which maximizes storage space in a warehouse or other facility. According to several embodiments, the tall structures may exceed a height of approximately 10 m; the tall structures may exceed a height of approximately 19 m; and/or the tall structures may exceed a height of approximately 25 m. According to several embodiment, the stacker crane 10 may be designed to access a height greater than 10 m, to access a height greater than approximately 19 m, and/or to access a height greater than approximately 25 m.

FIG. 1 illustrates the narrow aisle crane 100, which includes a base unit 120, a mast structure 130, a hoisting carriage 140, and a load-carrying platform 150, among other structures. According to one arrangement, the hoisting carriage 140 may be configured to accommodate an operator 160.

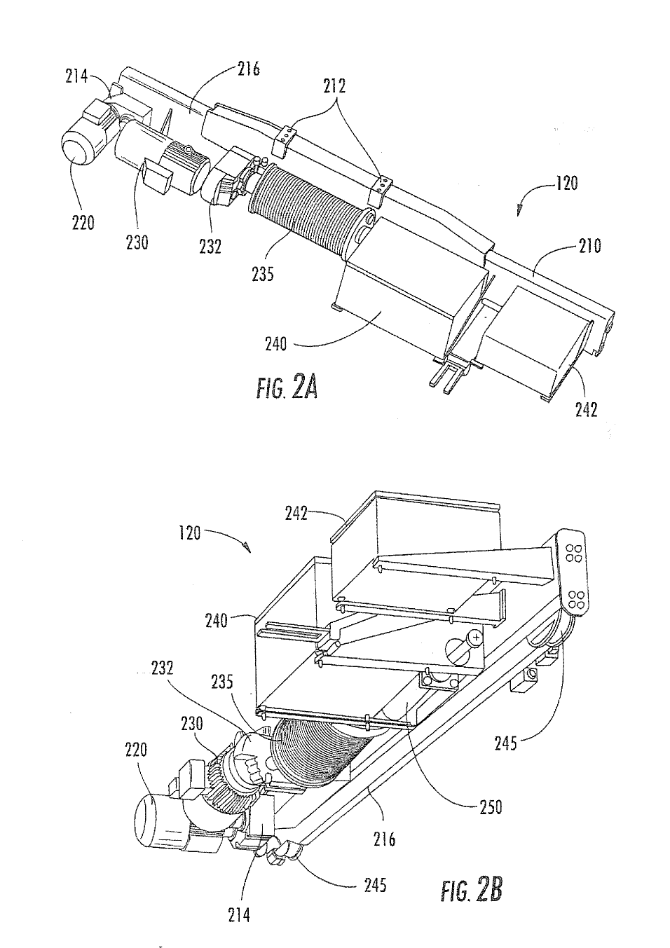

According to one embodiment illustrated in FIG. 2A, the base unit 120 may include a traverse 210. According to one arrangement, the traverse 210 is constructed of a durable material, such as metal or other durable material. For example, the traverse 210 may be made from bended steel sheet channels that are joined together longitudinally by welding. According to one embodiment, the traverse 210 may be reinforced with internal diaphragms to withstand stresses that may arise during operation. According to one embodiment, stresses that are imparted to the traverse 210 may include braking stresses, fatigue stresses and/or other stresses.

According to one arrangement, the traverse 210 may include a mast connecting surface 212 that is positioned on an upper surface of the traverse 210. The mast connecting surface 212 is configured to receive the mast structure 130. According to one embodiment of the invention, the mast connecting surface 212 may be provided at a middle portion of the traverse 210, wherein the middle portion is defined along a length of the traverse 210. Alternatively, the mast connecting surface 212 may be provided at a position that is offset from the middle portion of the traverse 210. According to one arrangement of the invention, the mast connecting surface 212 may be directly coupled to the mast structure 130 using high strength bolted joints. One of ordinary skill in the art will readily appreciate that other types of connections may be employed for directly or indirectly coupling the mast structure 130 to the mast connecting surface 212.

According to one arrangement illustrated in FIG. 2B, the traverse 210 may include transport mechanisms, such as wheels 245. According to one arrangement, the wheels 245 may be provided at opposite end portions of the traverse 210. One or more of the wheels 245 may be flanged, and/or may be constructed of high strength alloy steel. According to one arrangement, one or more of the wheels 245 may be surface hardened on portions that contact a guide mechanism. In another arrangement, one or more of the wheels 245 may be imparted with a motive force, such as from a motor coupled thereto.

According to one arrangement of the invention, the traverse 210 can include a lateral surface 216 that may be employed to affix several components. In one arrangement, the lateral surface 216 may face toward the aisle so as to extend below the hoisting carriage 140. A first motor 220 may be fastened to the lateral surface 216. According to one arrangement of the invention, a first motor 220 may be fastened to the lateral surface 216 through a gear reducer 214. The gear reducer 214 may be coupled to the lateral surface 216 through a torque arm that prevents rotation of the gear reducer 214. An intercalated resilient rubber buffer may be provided at the torque arm to smoothen operation of the first motor 220 and the gear reducer 214.

A second motor 230 may be coupled to the lateral surface 216. A second motor 230 may be coupled to a rope drum assembly 235. The second motor 230 also may be coupled to a rope drum assembly 235 through a hoisting gear reducer 232. The rope drum assembly 235 and the hoisting gear reducer 232 may be coupled to the lateral surface 216. Electric cabinets 240,242 may be mounted on apposite brackets that are coupled to the lateral surface 216 in one arrangement. The electric cabinets 240, 242 may include a housing that is constructed from sheet metal or other material. A shock absorber 250 may be provided between the electric cabinet 240 and the lateral surface 216 and may project outwardly therefrom. The shock absorber 250 can be configured to be depressed upon contact with an obstacle and/or an end stop during travel. Depressing the shock absorber 250 can disable the driving force provided by one or more motors 220, 230. One of ordinary skill in the art will readily appreciate that the shock absorber 250 may be positioned at other locations and/or that a plurality of shock absorbers may be employed.

According to one arrangement of the invention, the first motor 220 can provide a motive force that imparts a velocity to drive the base unit 120 in the horizontal direction relative to the floor. The velocity of the base unit 120, and hence the stacker crane 100, may be designed to be approximately 1 m/s to approximately 5 m/s, and in a presently preferred arrangement may be approximately 2 m/s.

The first motor 220 can be mounted with a shrink disk to avoid key/keyway wear and tear that typically result from alternating motion. According to one arrangement, a high speed limit switch may be provided to prevent the base unit 120 from traveling at the maximum speed when the base unit 120 is located proximate to an end of the aisle. An ultimate limit switch may be provided to prevent the base unit 120 from traveling beyond the aisle. The gear reducer 214 may be directly coupled to an asynchronous AC squirrel-cage brake motor that is controlled by a frequency inverter to allow two level speed selection. According to one arrangement, the first motor 220 may include motor rated power of 3 kW.

The second motor 230 can provide a motive force that imparts a velocity to drive the hoisting carriage 140 and the load-carrying platform 150 in the vertical direction relative to the floor. The velocity of the hoisting carriage 140 and the load-carrying platform 150 as they travel up and down the mast structure 130 may be designed to be up to approximately 1.5 m/s and in one arrangement may be approximately 0.45 m/s.

The hoisting gear reducer 232 may be mounted on the hoisting drum support shaft extension and may be prevented from rotating by a flange mounted torque arm that is anchored to the lateral surface 216. According to one arrangement of the invention, the hoisting gear reducer 232 may be directly coupled to an asynchronous AC squirrel-cage brake motor that is controlled by a frequency inverter to allow two level speed selection. The second motor 230 may include motor rated power of 4 kW. In one arrangement of the invention, an overload switch may be provided to prevent overloading of the hoisting carriage 140 and/or the load-carrying platform 150. In another arrangement of the invention, a high speed limit switch may be provided to prevent the hoisting carriage 140 from traveling at the maximum speed when the hoisting carriage 140 is located proximate to the bottom or the top of the mast structure 130. An ultimate limit switch may be provided to prevent the hoisting carriage 140 from traveling beyond the top of the mast structure 130. Further, a slack rope detection device may be provided to avoid a slack rope condition.

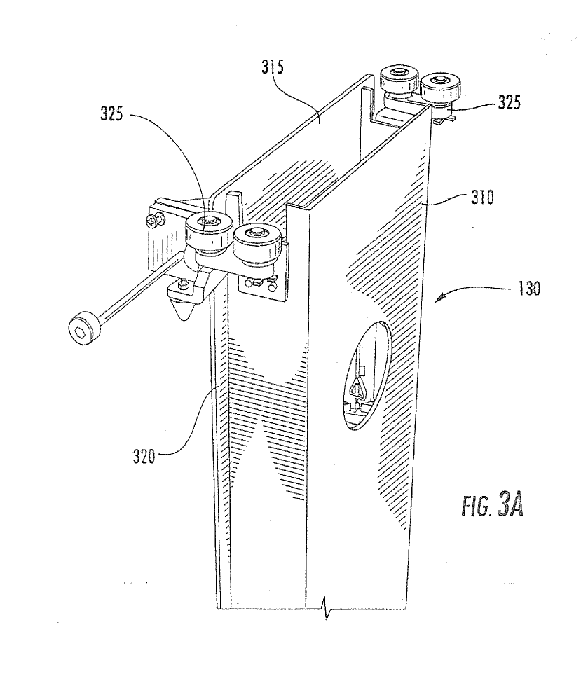

According to one arrangement of the invention illustrated in FIG. 3A, an upper portion of the mast structure 130 is provided from a rear perspective. The mast structure 130 may include a welded box girder 310 that is formed from a “U” shaped steel plate that can be joined by longitudinal welding to a flat member 315. The flat member 315 may include openings that define a ladder that may be employed by an operator as an escape route during a power failure, a hoisting malfunction or other problem. According to one arrangement of the invention, the mast structure 130 may include protruding longitudinal flanges 320 that serve as guide profiles for guide rollers that are provided on the hoisting carriage 140. The protruding longitudinal flanges 320 may serve as an emergency catch grip surface. Guiding rollers 325 may be provided on the upper portion of the mast structure 130 to engage a guiding rail, which can provide structural support to the upper portion of the mast structure 130.

According to one arrangement of the invention illustrated in FIG. 3B, an upper portion of the mast structure 130 is provided from a front perspective. A rope return sheave 330 can be provided on the upper portion of the mast structure. A second sheave can be provided at the hoisting carriage 140. According to one arrangement of the invention, a wire rope can be extend upward from the hoisting drum 235 to the rope return sheave 330, which turns the wire rope by approximately 180 degrees. The wire rope can descend through the mast structure to engage the second sheave 415 provided at the hoisting carriage 140, which can turn the wire rope 407 by approximately 180 degrees. The wire rope 407 can extend upward and be anchored at a point on top of the mast structure 130. As a result, the rope return sheave 330 and the second sheave 415 can define a pulley system. According to one arrangement, the wire rope 407 is a multi-strand rope that may be dye formed and may include a plasticized steel core. One of ordinary skill in the art will readily appreciate that other types of wire rope may be employed.

According to one arrangement of the invention, a speed governor assembly 340 can be provided on the upper portion of the mast structure 130 to limit the vertical velocity imparted on the hoisting carriage 140. A shock absorber 345 may be positioned at the upper portion of the mast structure 130 to project outwardly therefrom. The shock absorber 345 can be configured to be depressed upon contact with an obstacle and/or an end stop during travel. Depressing the shock absorber 345 can disable the driving force provided by one or more motors 220, 230. One of ordinary skill in the art will readily appreciate that the shock absorber 345 may be positioned at other locations and/or that a plurality of shock absorbers may be employed.

According to one arrangement of the invention, the mast structure 130 height may be greater than approximately 10 m. In other arrangements, the mast structure 130 height may be greater than approximately 15 m, and in further arrangements the mast structure 130 height may be greater than approximately 18 m. According yet further arrangements of the invention, the mast structure 130 height may be approximately 25 m. The mast structure 130 height in some arrangements may be greater than 25 m, depending on the economics and safety of providing a higher mast. Factors that may limit the height of the mast structure 130 include the size of the hoisting carriage 140 and the power of the motors that operate the crane 100. According to one arrangements of the invention, the mast structure 130 may have a width of approximately 0.75 m, although the width of the mast structure 130 may advantageously be approximately 0.6 m to approximately 0.9 m.

According to one arrangement of the invention illustrated in FIG. 4, the hoisting carriage 140 and the load carrying platform 150 may be constructed of a welded tubular frame. Protection panels 405 may be provided along selected perimeter portions of the hoisting carriage 160. The protection panels 405 may be formed by an aluminum plate up to approximately a waist line of the operator. In some arrangements, polycarbonate transparent anti-shock panels may be provided above the protection panels 405, and/or a roof of the hoisting carriage 140 may be enclosed with a panel, such as an aluminum panel. The hoisting carriage 140 may include light sources to illuminate the operator area and/or other areas.

The hoisting carriage 140 may include a working area that is suitable for an operator 160. in some arrangements of the invention, the hoisting carriage 140 may include a working area of approximately 740 mm wide by 910 mm long. An operator driving area may be located between the hoisting carriage 140 and the load carrying platform 150, and may include a seat for the operator. Additionally, the operator driving area may include a command center with controls, such as one or more joysticks to provide directional control of the hoisting carriage 140 and/or the base unit 120. According to a presently preferred arrangement of the invention, an operator back contact point may be provided for safety. The operator back contact point may shut down the stacker crane if the operator does not place his or her back against the contact point and his or her hands on the controls at a same time.

According to one arrangement of the invention, the hoisting carriage 140 may be accessible from various locations. For example, the hoisting carriage 140 may be accessible from any side. The hoisting carriage 140 may include a plurality of access doors, which may be provided along the walls of the hoisting carriage 140 and/or on the floor of the hoisting carriage 140. The access doors may be configured with safety features that stop the stacker crane 100 if any door is opened during operation.

The hoisting carriage 140 and/or the load carrying platform 150 may include a plurality of guide rollers 420 that engage the protruding longitudinal flanges 320, which are provided on the mast structure 130. According to one arrangement, at least four sets of guide rollers 420 may be provided at the hoisting carriage 140 to engage the protruding longitudinal flanges 320 that are provided on the mast structure 130. In one arrangement, the hoisting carriage 140 may be provided with a catching device that operates instantaneously upon over speed caused by a malfunction, such as a controller malfunction, a rope failure, a mechanical breakdown on the hoisting drive or any other malfunction. The catching device may be a roller and ramp type, and/or may include engaging the speed governor to stop movement of the hoisting carriage 140.

The load carrying platform 150 may be configured to receive pallets, and as such, the load carrying platform 150 may include a ball conveyor 455 for receiving the pallets. The pallets may be secured using moveable stoppers that mechanically restrain the pallets. According to one arrangement of the invention, the load carrying platform 150 may be physically separated from the operator area via an internal fence.

The first motor 220, the second motor 230, the rope drum assembly 235, the gear reducer 214, the hoisting gear reducer 232, electrical cabinets 240,242, among other components, may be positioned on a side of the traverse 120 located below the hoisting carriage 160 and the load carrying platform 150. According to one arrangement of the invention, the first motor 220, the second motor 230, the rope drum assembly 235, the gear reducer 214, the hoisting gear reducer 232, electrical cabinets 240,242, among other components, can be oriented to enable the bottom of the load carrying platform 150 to have a lowest possible loading height of approximately 0.3 m to approximately 0.7 m above ground, and may be arranged to be approximately 0.45 m above ground. By contrast, a typical lowest loading height for stacker crane installations is 1 m above ground, meaning that the lowest shelf height of a typical stacker crane installation is similarly 1 m above ground. The present invention enables the lowest shelf height to be 0.45 m above ground (or the height that is selected for the particular application). As a result, the invention enables an extra shelving level compared to known systems. This is particularly the case with document storage and retrieval applications, where the document boxes to be stored are less than 0.45 m high.

The stacker crane 100 can be dimensioned to operate in an aisle that is approximately 970 mm wide. The hoisting carriage 140 may include a width of approximately 0.8 m to approximately 1.3 m depending on the width of the aisle it is to be used in. For example, According to one embodiment of the invention, the hoisting carriage 140 may include a width of approximately 0.9 m to approximately 1 m. The hoisting carriage 140 may include a length of up to approximately 4.5 m. such as, for example, approximately 3 m to approximately 3.5 m.

As discussed above, according to one arrangement of the invention, the velocity of the base unit 120, and hence the stacker crane 100, may be designed to be approximately 2 m/s, although may advantageously be designed to be between approximately 1 m/s to approximately 5 m/s. Furthermore, the velocity of the hoisting carriage 140 and the load-carrying platform 150 as they travel up and down the mast structure 130 may be designed to be up to approximately 1.5 m/s, and in one arrangement, up to approximately 0.45 m/s. These velocities can provide a reasonable compromise between travel velocities and a need for additional hoisting carriage breaking equipment, which adds to the weight of the hoisting carriage 140. In particular, the relatively slow velocity of vertical movement for the hoisting carriage 140 provided by the invention means that it is not necessary to provide extensive and heavy breaking systems on the hoisting carriage 140. Any weight savings that can be attributed to lighter braking systems can reduce power requirements for the motors as higher speeds are sought.

In order to improve access speed, the hoisting carriage 140 and the load-carrying platform 150 may move concurrently in the horizontal and vertical directions relative to the floor. The concurrent movement, which is further enabled by the relatively low weight of the hoisting carriage 140 and the load carrying platform 150, can substantially increase the speed at which an operator can access a desired shelving level when compared with non-concurrent horizontal and vertical movements. Thus, despite the relatively low travel velocities in the horizontal and vertical directions, high item retrieval efficiency can be achieved.

Several benefits can be provided by configuring the hoisting carriage 140 to carry an operator 160 for controlling the hoisting carriage 140 and moving the goods between the load-carrying platform 150 and the shelving. Benefits include eliminating weight on the hoisting carriage 140 for pallet forks and controls that are needed to automatically handle stacker retrieval systems. In one arrangement, the hoisting carriage 140 and the load-carrying platform 150 may be designed to have a maximum loading capacity (including the operator) of approximately 350 kg to approximately 650 kg, such as for example, approximately 500 kg. This can ensure that the hoisting carriage 140 and load-carrying platform 150 do not need to be as heavy as typical stacker cranes, which have loading capacities of 1-2 tons. The reduction in weight to be lifted by the motor that powers the vertical movement of the hoisting carriage 140 and load-carrying platform 150 can ensure that the motor may be relatively limited in power. The cost-savings due to these features can be quite substantial when compared with traditional warehousing systems.

The base unit 120 may run on rails 600 that are installed along the various aisles, and may be recessed below the floor level in one arrangement, running parallel with the shelving stacks. According to another arrangement, the rails 600 may be raised above the floor level.

In order to use multiple aisles of a warehouse, either dedicated stacker cranes may be provided, one for each aisle, or the stacker crane must have the ability to move between aisles of the warehouse. There are two main methods of enabling a crane to move between aisles of a warehouse, which are to use a curved rail at the end of an aisle, or to use transfer cars which provide a base into which the crane drives at the end of an aisle. The transfer car can move on rails which extend perpendicularly to the rails within the aisles, the transfer rails extending along the ends of the aisles to align the crane with a rail extending along the length of the adjacent aisle. The crane may then exit the transfer car and move along the new warehouse aisle. There are different ways of achieving appropriate transfer car usage, including a dedicated transfer car for each crane in a warehouse, and a single transfer car for each end of a warehouse that may be called for when needed by an operator. Any of these and other suitable solutions may be employed for moving the stacker crane of the present invention between warehouse aisles, depending on the particular application.

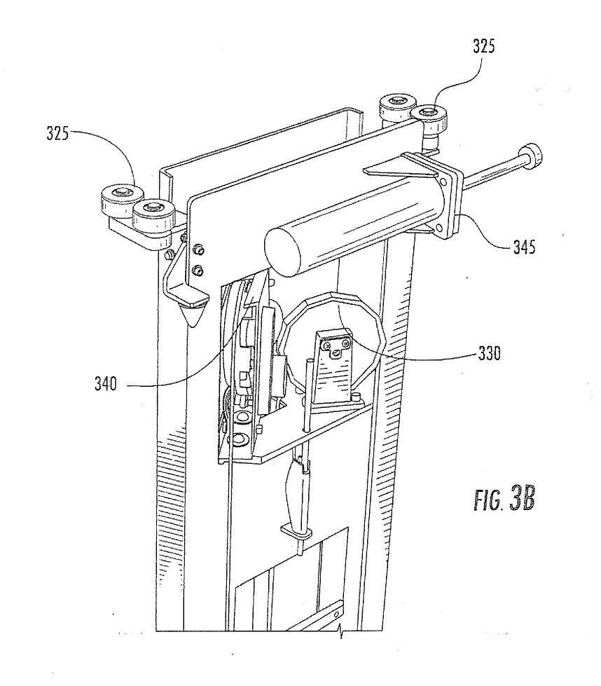

According to one arrangement of the invention illustrated in FIG. 5, a transfer car 500 can be provided to transfer a stacker crane 100 between aisles. The transfer car 500 can run along transfer car running rails 610 that extend perpendicular to the warehouse aisles, at each end of the aisles. According to one arrangement, the transfer car 500 may include a platform 505, which may be constructed from welded structural hollow sections and steel sheet channels that are joined together by welding. The platform 505 may include a rail 510 for receiving the stacker crane 100. According to one embodiment, the platform 505 may include a column 515 and support rollers 520 that support the stacker crane 100, including the mast structure 130, in an upright position. A moving mechanism 525 may be provided to include wheels 530 and a motor 535 to move the transfer car 500 and stacker crane 100 together between aisles on the transfer rails 610. The transfer car 500 may include safety switches that prevent movement of the transfer car 500 when the stacker crane 100 is not properly mounted and/or secured.

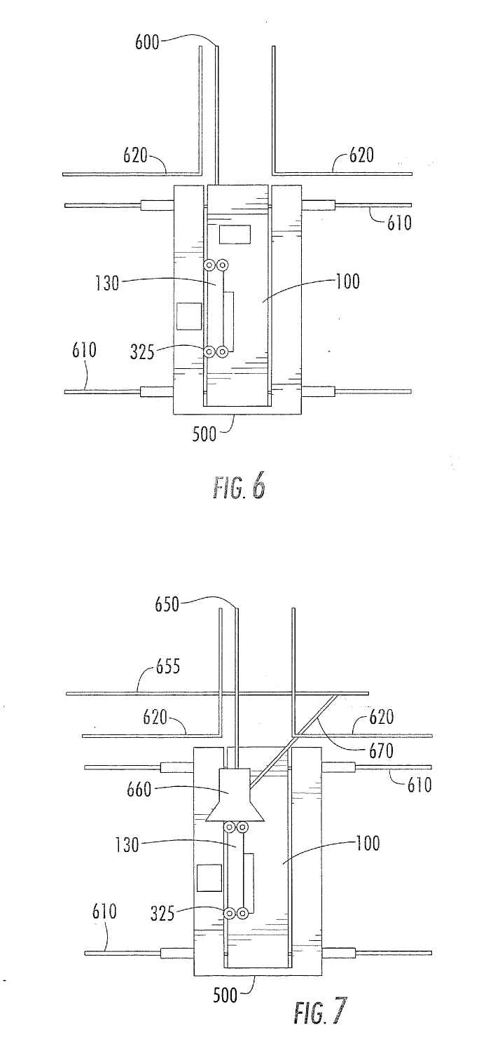

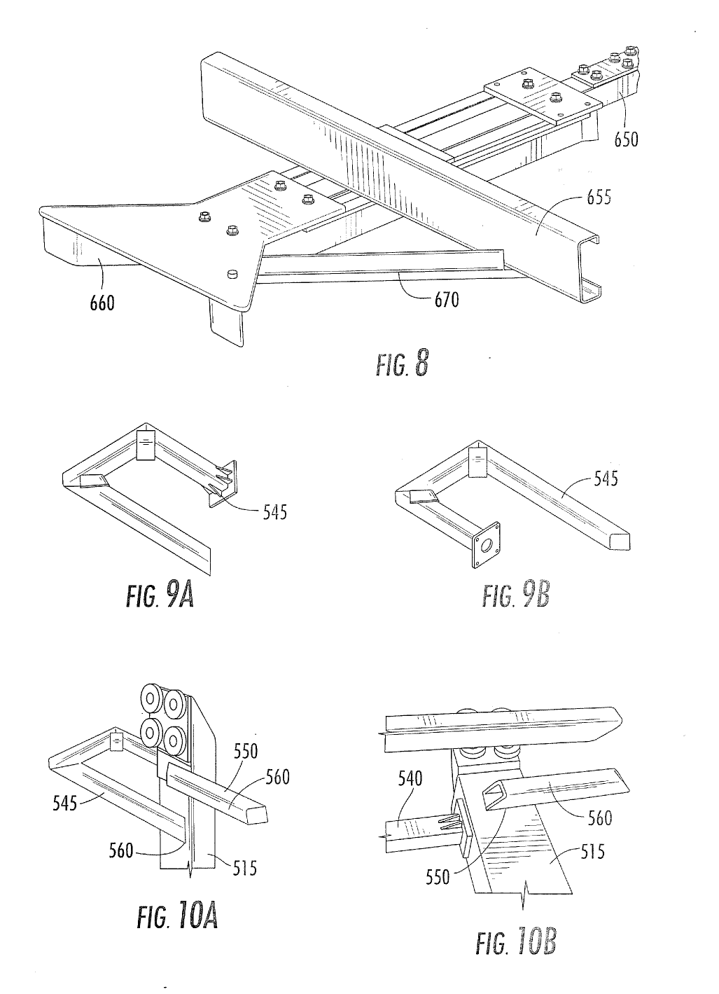

As shown in FIGS. 9a, 9b, 10a and 10b, the column 515 may include a guide structure 540 which provided support on both sides of the mast structure 130 once the stacker crane 100 has been moved onto the transfer car 500. The guide structure 540 prevents the mast structure 130 from tipping as the transfer car 500 is moved. The guide structure 540 can be formed of a generally J-shaped hook 545, and a straight guide section 550 which may both include plastic guide rails 560 to reduce friction as the mast structure 130 is maneuvered into place. Together the hook 545 and the straight guide section 550 form a generally U-shaped structure 540 to receive the mast structure 130.

It will be appreciated that the low weight-capacity stacker crane 100 of the present invention, which operates at relatively low speeds can ensure that the rail system may be substantially lighter than those used in conventional stacker crane installations. Thus, the stacker crane 100 may be easily moved onto a transfer car 500 to be transported to a different aisle.

According to one arrangement, parallel pairs of transfer car running rails 610 may be provided between adjacent rows having rails, which run perpendicularly to the rails 600 provided in the aisles. Alternatively, the transfer car running rails may be provided in a non-perpendicular orientations relative to the rails of adjacent aisles of shelving stacks 620. One of ordinary skill in the art will readily appreciate that various orientations between the transfer car running rails and the rails of adjacent rows may be employed.

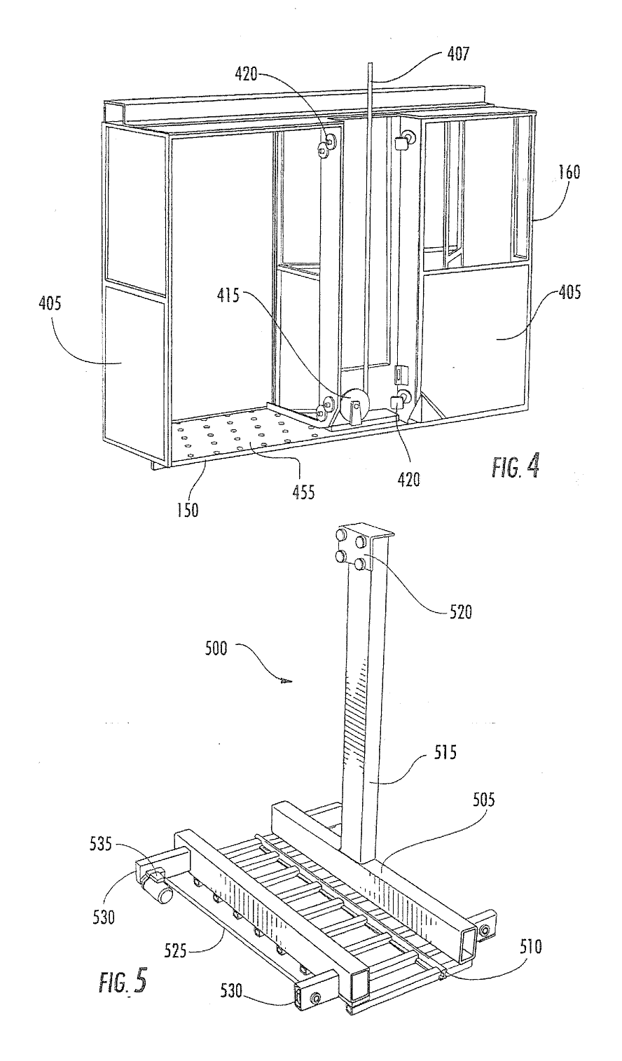

According to one arrangement of the invention as shown in FIGS. 6 and 7, an upper guiding rail 650 may be provided to engage an upper portion of the mast structure 130 at guiding rollers 325. The upper guiding rail 650 may include a “T” shaped profile, and may be affixed to rack portal beams 655 that are provided in a roof portion of a warehouse or other structure beneath the ceiling of the warehouse, or may be affixed to upper portions of the shelving systems 620. The upper guiding rails 650 can run generally parallel to the guide rails 600 within the aisles. Rail funnels 660 may be provided at the ends of the upper guiding rails 650, to direct the guiding rollers 325 onto the upper guiding rails 650 as the stacker crane 100 is moved from an aisle to a transfer car 500, and from the transfer car 500 to a new aisle. The rail funnels 660 may be generally Y-shaped so that any deviation of the masts 130, and hence the guiding rollers 325, that occurs during transport of the transfer car 500 can be corrected as the stacker crane 100 is moved off the transfer car 500 onto the guide rail 600. A brace 670 may be provided between the rail funnels 660 and the beams 655 to prevent any movement of the rail funnels 660 as the guiding rollers are maneuvered into place.

In order to assist in the transfer operation, CCTV cameras can be mounted on the column 515, or in fixed positions adjacent to the ends of the aisles, with views of the guide structure 540, and the rail funnels 660. The operator can then ensure by looking at the CCTV images that the guide rollers 325, and hence the top of mast structure 130 is located correctly before either moving the transfer car 500 to a new aisle, or before moving the stacker 100 off the transfer car 500 into the new aisle.

The foregoing is provided for purposes of illustrating, explaining, and describing embodiments of this invention. Modifications and adaptations to these embodiments will be apparent to those skilled in the art and may be made without departing from the scope or spirit of this invention. It will be apparent to those skilled in the art that other components performing the same function may be suitably substituted. The scope of the invention is determined solely by the appended claims.

We claim:

1. A stacker crane for use in narrow aisles, comprising:
a base unit;
a mast structure that is connected to the base unit;
an operator carriage and a load-carrying platform that are coupled to the mast structure, the carriage and load-carrying platform being arranged to travel vertically along the mast; and
at least one motor that is coupled to the base unit and is operable to move the carriage, the load-carrying platform and the base unit, the at least one motor being mounted on a side of the base unit that is below the carriage;
wherein the base unit and the carriage are dimensioned to travel along aisles of approximately 0.8 m to approximately 1.3 m in width,
wherein the base unit is configured to run along a lower rail structure, and the mast structure is configured to align with and run along an upper rail structure.

2. The stacker crane according to claim 1, wherein the at least one motor is configured to impart a velocity of approximately 1.5 m/s to approximately 3 m/s to the base unit in a direction that is horizontal relative to the floor.

3. The stacker crane according to claim 1, wherein the at least one motor is configured to impart a velocity of approximately 0.25 m/s to approximately 0.75 m/s to the carriage in a direction that is vertical relative to the floor.

4. The stacker crane according to claim 1, wherein a height of the mast structure is approximately 19 m to approximately 25 m.

5. The stacker crane according to claim 1, wherein the at least one motor is mounted on the side of the base unit below the carriage such that, when fully lowered, a height of the carriage is less than approximately 0.75 m.

6. The stacker crane according to claim 5, wherein, when fully lowered, the height of the carriage is between approximately 0.3 m to approximately 0.7 m.

7. The stacker crane according to claim 1, wherein a width of the mast structure is approximately 0.6 m to approximately 0.9 m.

8. The stacker crane according to claim 1, wherein the carriage includes a weight limit of approximately 350 kg to approximately 650 kg.

9. The stacker crane according to claim 1, wherein the base unit and the carriage are dimensioned to travel along aisles of approximately 0.9 m to approximately 1 m in width.

10. The stacker crane according to claim 1, wherein the carriage further comprises operator controls, the operator controls including a contact pad for the operator's back, such that the narrow stacker crane will not operate unless the operator is seated.

11. The stacker crane according to claim 1, wherein the base unit is configured to travel along the lower rail system at a velocity of approximately 2 m/s.

12. The stacker crane according to claim 1, wherein the upper rail system is positioned along a ceiling of a facility, the mast structure including guide rollers that are configured to travel along the upper rail system.

13. The stacker crane according to claim 12, comprising guiding means to align the guide rollers with the upper rail system.

14. A stacker crane assembly for use in traversing narrow aisles, comprising:
a stacker crane comprising:
a base unit;
a mast structure that is connected to the base unit;
an operator carriage and a load-carrying platform that are coupled to the mast structure, the carriage and the load-carrying platform being arranged to travel vertically along the mast; and
at least one motor that is coupled to the base unit and is operable to move the carriage, the load-carrying platform and the base unit, the at least one motor being mounted on a side of the base unit that is below the carriage;
a transfer car comprising:
a platform;
a rail provided in the platform; and
a support structure that is provided on the platform to engage the mast structure, the support structure comprising a guiding structure to guide the mast structure into alignment with the support structure.

15. The stacker crane assembly according to claim 14, further comprising a lower rail system that is positioned on a floor of the aisles, the base unit being configured to travel along the lower rail system.

16. The stacker crane assembly according to claim 14, further comprising a transfer car rail system that is positioned on a floor between the aisles, the transfer car being configured to travel along the transfer car rail system.

17. The stacker crane assembly according to claim 14, wherein the base unit is configured to travel along the lower rail system at a velocity of approximately 2 m/s.

18. The stacker crane assembly according to claim 14, further comprising an upper rail system that is positioned along a ceiling of a facility, the mast structure being configured to travel along the upper rail system.

19. The stacker crane assembly according to claim 18, wherein the mast structure includes guide rollers that are configured to travel along the upper rail system.

20. The stacker crane assembly according to claim 19, comprising guiding means to align the guide rollers with the upper rail system.

21. The stacker crane according to claim 14, wherein the transfer car comprises a moving mechanism and at least one motor.
